(19) United States
(12) Patent Application Publication
(10) Pub. No.: US 2015/0062775 A1
(43) Pub. Date: Mar. 5, 2015

(54) MULTILAYER CERAMIC CAPACITOR

(71) Applicant: TAIYO YUDEN CO., LTD., Tokyo (JP)

(72) Inventors: Ryuichi SHIBASAKI, Takasaki-shi (JP); Shinichi SASAKI, Takasaki-shi (JP); Naoki SAITO, Takasaki-shi (JP); Takafumi SUZUKI, Takasaki-shi (JP)

(21) Appl. No.: 14/469,231

(22) Filed: Aug. 26, 2014

(30) Foreign Application Priority Data
Aug. 30, 2013 (JP) 2013179361
Jul. 29, 2014 (JP) 2014153566

(51) Int. Cl. H01G 4/30; H01G 4/12; H01G 4/012

(52) U.S. Cl. CPC H01G 4/30; H01G 4/012; H01G 4/12
USPC 361/301.4

(57) ABSTRACT

A multilayer ceramic capacitor highly useful in suppressing noise in a mounted state includes a capacitor body of a multilayer ceramic capacitor. The capacitor body integrally has: a capacitive part constituted by multiple internal electrode layers stacked in the height direction via dielectric layers; a top protective part made of a dielectric and positioned on the top side of the top internal electrode layer among the multiple internal electrode layers; and a bottom protective part made of a dielectric and positioned on the bottom side of the bottom internal electrode layer among the multiple internal electrode layers; wherein the thickness Tc of a bottom protective part is greater than the thickness Tb of a top protective part so that the capacitive part is disproportionately positioned in the upper side of the capacitor body in its height direction.

### FIELD OF THE INVENTION

The present invention relates to a multilayer ceramic capacitor.

### DESCRIPTION OF THE RELATED ART

In general, a multilayer ceramic capacitor has a capacitor body of roughly rectangular solid shape specified by certain length, width and height, as well as external electrodes provided on the respective ends of the capacitor body in its length direction. The capacitor body integrally has a capacitive part constituted by multiple internal electrode layers stacked in the height direction via dielectric layers, a top protective part made of a dielectric and positioned on the top side of the top internal electrode layer among the multiple internal electrode layers, and a bottom protective part made of a dielectric and positioned on the bottom side of the bottom internal electrode layer among the multiple internal electrode layers (refer to FIG. 1 of Patent Literature 1 mentioned later, for example).

Such multilayer ceramic capacitor is mounted onto a circuit board by joining the joint surfaces of the external electrodes of the multilayer ceramic capacitor, using solder, onto the surfaces of pads provided on the circuit board. The outline shape of the surface of each pad is generally a rectangle larger than the outline shape of the joint surface of each external electrode, so a solder fillet based on free wicking of molten solder is formed on the end face of each external electrode after mounting (refer to FIGS. 1 and 2 of Patent Literature 1 mentioned later, for example).

When voltage, particularly alternating current voltage, is applied to both external electrodes via the pads in this mounted state, the capacitor body expands and contracts due to the electrostriction phenomenon (explained primarily as the capacitive part contracting in the length direction and subsequently restoring its original shape) and the stress generated by this expansion/contraction travels through the external electrode, solder, and pad, and transmits to the circuit board to induce vibration (explained primarily as the section between the pads concaving and subsequently restoring its original shape), and this vibration may generate audible sounds (so-called noise).

Patent Literature 1 mentioned later describes a mounting structure which is designed to suppress the aforementioned noise by keeping the “height of the solder fillet with reference to the pad surface” lower than the “spacing between the pad surface and capacitor body” plus the “thickness of the bottom protective part of the capacitor body” (refer to FIG. 2).

However, because the solder fillet is formed based on free wicking of molten solder relative to the end face of each external electrode, and also because the solder wettability on the end face of each external electrode is good, it is extremely difficult to control the “height of the solder fillet with reference to the pad surface” unless a special method is used.

To explain the above by giving a specific example, consider a multilayer ceramic capacitor whose end face height of each external electrode is 500 μm; with this multilayer ceramic capacitor, applying the same amount of solder may actually result in a solder fillet height far greater than 200 μm or less than 200 μm with reference to the bottom edge of the end face of the external electrode, which is recognized as an unmounted defect.

In other words, with the mounting structure described in Patent Literature 1 mentioned later, which does not adopt any special method to control the “height of the solder fillet with reference to the pad surface,” it is actually extremely difficult to keep the “height of the solder fillet with reference to the pad surface” lower than the “spacing between the pad surface and capacitor body” plus the “thickness of the bottom protective part of the capacitor body,” which minimizes the usefulness of this method in suppressing noise.

### BACKGROUND ART LITERATURES

[Patent Literature 1] Japanese Patent Laid-open No. 2013-046069

### SUMMARY

An object of the present invention is to provide a multilayer ceramic capacitor highly useful in suppressing noise in a mounted state.

Any discussion of problems and solutions in relation to the related art has been included in this disclosure solely for the purposes of providing a context for the present invention, and should not be taken as an admission that any or all of the discussion was known at the time the invention was made.

To achieve the aforementioned object, the present invention proposes a multilayer ceramic capacitor having a capacitor body of roughly rectangular solid shape specified by certain length, width, and height, as well as external electrodes provided on the respective ends of the capacitor body in its length direction; wherein the capacitor body integrally has: a capacitive part constituted by multiple internal electrode layers stacked in the height direction via dielectric layers, a top protective part made of a dielectric and positioned on the top side of the top internal electrode layer among the multiple internal electrode layers, and a bottom protective part made of a dielectric and positioned on the bottom side of the bottom internal electrode layer among the multiple internal electrode layers; and wherein the thickness of the bottom protective part is greater than the thickness of the top protective part so that the capacitive part is disproportionately positioned in the upper side of the capacitor body in its height direction.

According to the present invention, a multilayer ceramic capacitor very useful in suppressing noise in a mounted state can be provided.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features, and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 is a top view of a multilayer ceramic capacitor to which the present invention is applied (First Embodiment).

FIG. 2 is a longitudinal section view of section S-S in FIG. 1.

FIG. 3 is a partial longitudinal section view showing a structure constituted by the multilayer ceramic capacitor shown in FIGS. 1 and 2, being mounted on a circuit board.

FIG. 4 is a drawing showing the specifications and characteristics of effectiveness verification samples 1 to 5.

FIG. 5 is a longitudinal section view, corresponding to FIG. 2, of a multilayer ceramic capacitor to which the present invention is applied (Second Embodiment).

FIG. 6 is a drawing showing the specifications and characteristics of effectiveness verification sample 6.

FIG. 7 is a longitudinal section view, corresponding to FIG. 2, of a multilayer ceramic capacitor to which the present invention is applied (Third Embodiment).

FIG. 8 is a drawing showing the specifications and characteristics of effectiveness verification sample 7.

FIG. 9 is a longitudinal section view, corresponding to FIG. 2, of a multilayer ceramic capacitor to which the present invention is applied (Fourth Embodiment).

FIG. 10 is a drawing showing the specifications and characteristics of effectiveness verification sample 8.

FIG. 11 is a longitudinal section view, corresponding to FIG. 2, of a multilayer ceramic capacitor to which the present invention is applied (Fifth Embodiment).

FIG. 12 is a drawing showing the specifications and characteristics of effectiveness verification sample 9.

### DESCRIPTION OF THE SYMBOLS

10, 10-1, 10-2, 10-3, 10-4, 10-5—Multilayer ceramic capacitor, 11—Capacitor body, L—Length of capacitor body, W—Width of capacitor body, H—Height of capacitor body, 11a—Capacitive part, 11a1—Internal electrode layer, 11a2—Dielectric layer, 11b—Top protective part, 11c—Bottom protective part, 11c—Top part of bottom protective part, 11c2—Bottom part of bottom protective part, Ta—Thickness of capacitive part, Tb—Thickness of top protective part, Tc—Thickness of bottom protective part, 12—-External electrode.

### DETAILED DESCRIPTION OF EMBODIMENTS

### First Embodiment

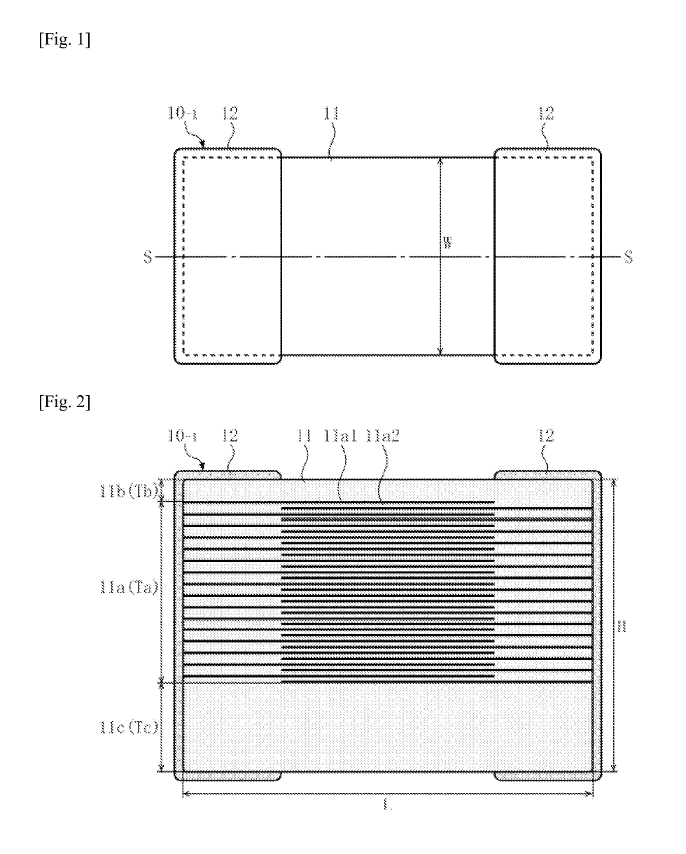

FIGS. 1 and 2 show the basic structure of a multilayer ceramic capacitor 10-1 to which the present invention is applied (First Embodiment). This multilayer ceramic capacitor 10-1 has a capacitor body 11 of roughly rectangular solid shape specified by certain length L, width W, and height H, as well as external electrodes 12 provided at the ends of the capacitor body 11 in its length direction.

The capacitor body 11 integrally has: a capacitive part 11a constituted by multiple (total 32 in the figure) internal electrode layers 11a1 stacked in the height direction via dielectric layers 11a2; a top protective part 11b made of a dielectric and positioned on the top side of the top internal electrode layer 11a1 among the multiple internal electrode layers 11a1; and a bottom protective part 11c made of a dielectric and positioned on the bottom side of the bottom internal electrode layer 11a1 among the multiple internal electrode layers 11a1. While FIG. 2 shows a total of 32 internal electrode layers 11a1 for the purpose of illustration, the number of internal electrode layers 11a1 is not limited in any way.

The multiple internal electrode layers 11a1 included in the capacitive part 11a each have a roughly equivalent rectangular outline shape as well as a roughly equivalent thickness. In addition, the multiple dielectric layers 11a2 (layers including the parts sandwiched by the adjacent internal electrode layers 11a1 and the periphery parts not sandwiched by the internal electrode layers 11a1) included in the capacitive part 11a each have a roughly equivalent outline shape which is a rectangle larger than the outline shape of the internal electrode layer 11a1, as well as a roughly equivalent thickness. As is evident from FIG. 2, the multiple internal electrode layers 11a1 are staggered in the length direction, where the edge of an odd-numbered internal electrode layer 11a1 from the top is electrically connected to the left external electrode 12, while the edge of an even-numbered internal electrode layer 11a1 from the top is electrically connected to the right external electrode 12.

The multiple internal electrode layers 11a1 included in the capacitive part 11a are each constituted by a conductor of the same composition, where preferably a good conductor primarily constituted by nickel, copper, palladium, platinum, silver, gold, or any alloy thereof, etc., can be used for this conductor. In addition, the multiple dielectric layers 11a2 included in the capacitive part 11a are each constituted by a dielectric of the same composition, where preferably a dielectric ceramic primarily constituted by barium titanate, strontium titanate, calcium titanate, magnesium titanate, calcium zirconate, calcium zirconate titanate, barium zirconate, titanium oxide, etc., or more preferably a dielectric ceramic of ε>1000 or Class 2 (having a high dielectric constant), can be used. “Same composition” mentioned in this paragraph means the same constituents, and it does not necessarily mean the same constituents where each constituent is contained by the same amount.

The composition of the top protective part 11b and that of the bottom protective part 11c are the same as the composition of the multiple dielectric layers 11a2 included in the capacitive part 11a. In this case, the dielectric constant of the top protective part 11b and that of the bottom protective part 11c are equivalent to the dielectric constant of the multiple dielectric layers 11a2 included in the capacitive part 11a. In addition, the thickness Tc of the bottom protective part 11c is greater than the thickness Tb of the top protective part 11b so that the capacitive part 11a is disproportionately positioned in the upper side of the capacitor body 11 in its height direction. “Same composition” mentioned in this paragraph also means the same constituents, and it does not necessarily mean the same constituents where each constituent is contained by the same amount.

When the thickness Tb of the top protective part 11b and thickness Tc of the bottom protective part 11c are each expressed by a ratio to the height H of the capacitor body 11, preferably the thickness Tb satisfies the condition of Tb/H≦0.06, while preferably the thickness Tc satisfies the condition of Tc/H≧0.20. Moreover, when the thickness Tb of the top protective part 11b and thickness Tc of the bottom protective part 11c are expressed by a ratio of both, preferably the thickness Tb and thickness Tc satisfy the condition of Tc/Tb≧4.6. Furthermore, when the height H and width W of the capacitor body 11 are expressed by a ratio of both, preferably the height H and width W satisfy the condition of H>W.

Each external electrode 12 covers an end face of the capacitor body 11 in its length direction and parts of the four side faces adjoining the end face, and the bottom face of the part covering parts of the four side faces is used as a joint surface at the time of mounting. Although not illustrated, each external electrode 12 has a two-layer structure comprising a base film contacting the exterior surface of the capacitor body 11 and a surface film contacting the exterior surface of the base film, or a multi-layer structure having at least one intermediate film between a base film and surface film. The base film is constituted by a baked conductor film, for example, and a good conductor primarily constituted by nickel, copper, palladium, platinum, silver, gold, or any alloy thereof, etc., can be used for this conductor. On the other hand, the surface film is constituted by a plated conductor film, for example, and a good conductor primarily constituted by tin, palladium, gold, zinc or any alloy thereof, etc., can be used for this conductor. Furthermore, the intermediate film is constituted by a plated conductor film, for example, and a good conductor primarily constituted by platinum, palladium, gold, copper, nickel, or any alloy thereof, etc., can be used for this conductor.

Here, a favorable example of manufacturing the multilayer ceramic capacitor 10-1 shown in FIGS. 1 and 2 is presented. If the primary constituent of the multiple internal electrode layers 11a1 included in the capacitive part 11a is nickel, and the primary constituent of the multiple dielectric layers 11a2 included in the capacitive part 11a, top protective part 11b, and bottom protective part 11c is barium titanate, then first of all an internal electrode layer paste containing nickel powder, terpineol (solvent), ethyl cellulose (binder), and dispersant and other additives is prepared, along with a ceramic slurry containing barium titanate powder, ethanol (solvent), polyvinyl butyral (binder), and dispersant and other additives.

Then, the ceramic slurry is coated onto a carrier film and dried, using a die-coater or other coating machine and a drying machine, to produce a first green sheet. In addition, the internal electrode layer paste is printed onto the first green sheet in a matrix or zigzag pattern and then dried, using a screen printer or other printing machine and a drying machine, to produce a second green sheet having internal electrode layer patterns formed on it.

Then, unit sheets that have been stamped out of the first green sheet are stacked until the specified quantity is reached, using a pickup head having stamping blades and heaters or other stacking machine, and then are thermally bonded, to produce a portion corresponding to the bottom protective part 11c. Next, unit sheets (including internal electrode layer patterns) that have been stamped out of the second green sheet are stacked until the specified quantity is reached and then they are thermally bonded, to produce a portion corresponding to the capacitive part 11a. Next, unit sheets that have been stamped out of the first green sheet are stacked until the specified quantity is reached and then they are thermally bonded, to produce a portion corresponding to the top protective part 11b. Next, the respective portions are stacked and then thermally bonded one last time, using a hot hydrostatic press or other final bonding machine, to produce an unsintered laminated sheet.

Then, the unsintered laminated sheet is cut into a grid pattern using a dicing machine or other cutting machine, to produce unsintered chips each corresponding to the capacitor body 11. Then, the many unsintered chips are sintered (the process includes both removal of binder and sintering) using a tunnel-type sintering furnace or other sintering machine, in a reducing ambience or ambience of low partial oxygen pressure according to a temperature profile appropriate for nickel and barium titanate, to produce sintered chips.

Then, an electrode paste (the internal electrode layer paste is used) is applied to the respective ends of a sintered chip in its length direction using a roller applicator or other application machine, and then dried and baked in an ambience similar to the one mentioned above to form a base film, on top of which a surface film, or an intermediate film and surface film, is/are formed by means of electroplating or other plating treatment, to produce external electrodes 12. The base film of each external electrode may also be produced by applying the electrode paste to the respective ends of an unsintered chip in its length direction, and drying and then baking the paste simultaneously with the unsintered chip.

FIG. 3 shows a structure constituted by the multilayer ceramic capacitor 10-1 shown in FIGS. 1 and 2, which is mounted on a circuit board 21. The circuit board 21 has a conductive pad 22 corresponding to each external electrode 12, and the joint surface of each external electrode 12 is joined to the surface of each pad 22 using solder 23. The outline shape of the surface of each pad 22 is generally a rectangle larger than the outline shape of the joint surface of each external electrode 12, and therefore a solder fillet 23a based on free wicking of molten solder is formed on an end face 12a of each external electrode 12 after mounting. Hf shown in FIG. 3 represents the height of a top point 23a1 of the solder fillet 23a with reference to the bottom face of the capacitor body 11.

Here, a favorable example of mounting the multilayer ceramic capacitor 10-1 shown in FIGS. 1 and 2 is presented. First, an appropriate amount of cream solder is applied onto each pad 22 of the circuit board 21. Then, the multilayer ceramic capacitor 10-1 is placed on the applied cream solder so that the joint surface of each external electrode 12 makes contact. Then, the cream solder is melted by the reflow soldering method or other heat treatment and then cured, to join a surface-to-be-joined of each external electrode 12 to the surface of each pad 22 via the solder 23.

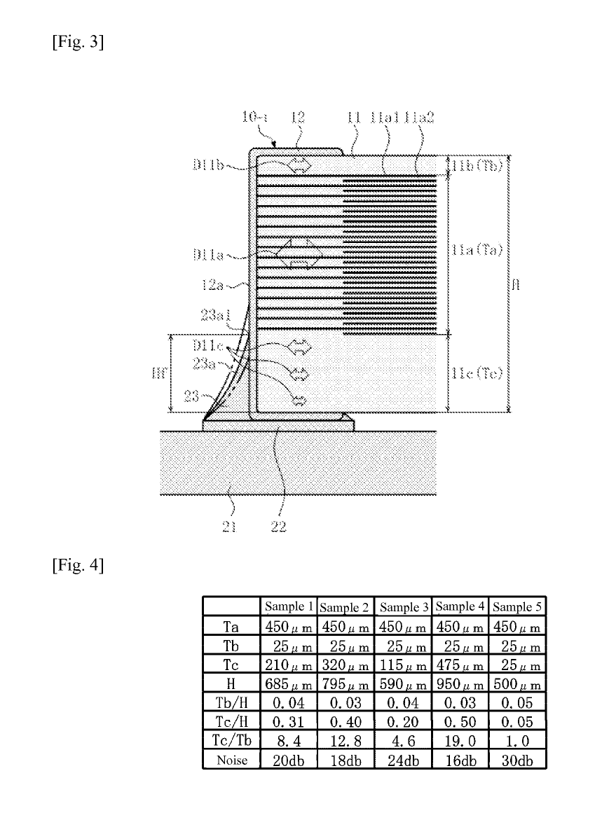

FIG. 4 shows the specifications and characteristics of samples 1 to 5 prepared to verify the effects obtained by the multilayer ceramic capacitor 10-1 shown in FIGS. 1 and 2.

Samples 1 to 5 shown in FIG. 4, produced according to the aforementioned manufacturing example, have the basic specifications as described below.

### <Basic Specifications of Sample 1>

The length L, width W, and height H of the capacitor body 11 are 1000 μm, 500 μm, and 685 μm, respectively. The thickness Ta of the capacitive part 11a is 450 μm, thickness Tb of the top protective part 11b is 25 μm, and thickness Tc of the bottom protective part 11c is 210 μm. The number of internal electrode layers 11a1 included in the capacitive part 11a is 350, number of dielectric layers 11a2 is 349, thickness of each internal electrode layer 11a1 is 0.7 μm, and thickness of each dielectric layer 11a2 is 0.6 μm. The primary constituent of each internal electrode layer 11a1 included in the capacitive part 11a is nickel, while the primary constituent of each dielectric layer 11a2 included in the capacitive part 11a and of the top protective part 11b and bottom protective part 11c is barium titanate. The thickness of each external electrode 12 is 10 μm, and the length of its part covering parts of the four side faces is 250 μm. Each external electrode 12 has a three-layer structure comprising a base film primarily constituted by nickel, intermediate film primarily constituted by copper, and surface film primarily constituted by tin.

### <Basic Specifications of Sample 2>

Sample 2 is the same as sample 1, except that the thickness Tc of the bottom protective part 11c is 320 μm and the height H of the capacitor body 11 is 795 μm.

### <Basic Specifications of Sample 3>

Sample 3 is the same as sample 1, except that the thickness Tc of the bottom protective part 11c is 115 μm and the height H of the capacitor body 11 is 590 μm.

### <Basic Specifications of Sample 4>

Sample 4 is the same as sample 1, except that the thickness Tc of the bottom protective part 11c is 475 μm and the height H of the capacitor body 11 is 950 μm.

### <Basic Specifications of Sample 5>

Sample 5 is the same as sample 1, except that the thickness Tc of the bottom protective part 11c is 25 μm and the height H of the capacitor body 11 is 500 μm.

The value of Tb/H in FIG. 4 represents the thickness Tb of the top protective part 11b as a ratio to the height H of the capacitor body 11 (average of 10 units), the value of Tc/H represents the thickness Tc of the bottom protective part 11c as a ratio to the height H of the capacitor body 11 (average of 10 units), and the value of Tc/Tb represents the thickness Tb of the top protective part 11b and thickness Tc of the bottom protective part 11c as a ratio of both (average of 10 units).

The value of noise in FIG. 4 represents the result of measuring 10 units of mounting structures of each of samples 1 to 5 produced as described below (average of 10 units), wherein, specifically, 5 V of alternating current voltage was applied to the external electrodes 12 of samples 1 to 5 by raising the frequency from 0 to 1 MHz and the intensity of generated audible noise (in units of db) was measured separately in a soundproof anechoic chamber (manufactured by Yokohama Sound Environment Systems) using Type-3560-B130 manufactured by Brüel & Kjaer Japan.

Each mounting structure was produced according to the mounting example mentioned above, where the basic specifications of each structure are described below.

### <Basic Specifications of Mounting Structures>

The thickness of the circuit board 21 is 150 μm and its primary constituent is epoxy resin. The length, width, length-direction spacing, and thickness of each pad 22 are 400 μm, 600 μm, 400 μm and 15 μm, respectively, and its primary constituent is copper. The cream solder is of tin-antimony type. The amount of cream solder applied onto each pad 22 is 50 μm in equivalent thickness. Each sample 1 to 5 is placed in such a way that the width-direction center of a surface-to-be-joined of each external electrode 12 corresponds with the width-direction center of the surface of each pad 22, while the end face of each external electrode 12 roughly corresponds with the length-direction center of the surface of each pad 22.

Since an ideal upper limit of noise is said to be 25 db in general, sample 5 among samples 1 to 5 shown in FIG. 4 does not appear effective in suppressing noise because its value of noise exceeds 25 db; whereas, the values of noise of samples 1 to 4 are all less than 25 db, indicating that samples 1 to 4, representing the multilayer ceramic capacitor 10-1 shown in FIGS. 1 and 2, are effective in suppressing noise.

The following explains, with respect to the multilayer ceramic capacitor 10-1 shown in FIGS. 1 and 2, a value range of Tb/H, value range of Tc/H, and value range of Tc/Tb that are favorable in terms of suppressing noise after considering the Tb/H values, Tc/H values, Tc/Tb values, and values of noise of samples 1 to 4 shown in FIG. 4.

### <Value Range of Tb/H>

To position the capacitive part 11a disproportionately in the upper side of the capacitor body 11 in its height direction, it is better to make the thickness Tb of the top protective part 11b as small as possible. To achieve the specified protection effect from the top protective part 11b, however, practically a thickness of 20 to 35 μm is required at least. When the upper limit of this value range, or 35 μm, is applied to samples 1 to 4, the maximum value of Tb/H becomes 0.06, indicating that preferably the thickness Tb of the top protective part 11b satisfies the condition of Tb/H<0.06. Also when the lower limit of the aforementioned value range, or 20 μm, is applied to samples 1 to 4, the minimum value of Tb/H becomes 0.02, indicating that more preferably the thickness Tb of the top protective part 11b satisfies the condition of 0.02≦Tb/H≦0.06.

### <Value Range of Tc/H>

As is shown by the outline arrows in FIG. 3, the extension and contraction occurring at the external electrode 12 in its length direction when alternating current voltage is applied is not uniform in the height direction, but the maximum amount of extension/contraction D11a manifests at the capacitive part 11a where the highest electric field intensity generates. The electric field intensities generating at the top protective part 11b and bottom protective part 11c are much lower than the electric field intensity at the capacitive part 11a and their respective amounts of extension/contraction D11b and D11c are much lower than the amount of extension/contraction D11a of the capacitive part 11a, but the stress accompanying the extension and contraction of the capacitive part 11a transmits, without attenuating, to the top protective part 11b and the top part of the bottom protective part 11b. However, so long as the bottom protective part 11c has a sufficient thickness Tc, the stress transmitted from the top part of the bottom protective part 11c to the lower side can be gradually attenuated to gradually reduce the amount of extension/contraction D11c.

On the other hand, a solder fillet 23a like the one shown in FIG. 3 is formed on the end face of the external electrode 12 at the time of mounting. Since this solder fillet 23a is based on free wicking of molten solder relative to the end face 12a of the external electrode 12, the height Hf of the top point 23a1 of the solder fillet 23a actually changes even when the amount of solder is the same. To be specific, unmounted defects, should they occur, may represent different cases where the height Hf of the top point 23a1 of the solder fillet 23a is roughly the same as the top face of the bottom protective part 11c (refer to the solid line), where this height Hf is higher than the top face of the bottom protective part 11c (refer to the upper double-dashed chain line), and where this height Hf is lower than the top face of the bottom protective part 11c (refer to the lower double-dashed chain line).

One characteristic common to all cases is that the solder fillet 23a has a section shape that is the thinnest at the top point 23a1 and gradually becomes thicker toward its bottom. In other words, the thin areas of the solder fillet 23a are expected to have flexibility, which means that, even when the height Hf of the top point 23a1 of the solder fillet 23a is higher than the top face of the bottom protective part 11c (refer to the upper double-dashed chain line), the amount of extension/contraction D11a of the capacitive part 11a can be absorbed by the aforementioned flexibility and the greatest amount of extension/contraction D11c of the bottom protective part 11c can also be absorbed by this flexibility. For the latter statement, the same is true with the cases where the height Hf of the top point 23a1 of the solder fillet 23a is roughly the same as the top face of the bottom protective part 11c (refer to the solid line) and where this height Hf is lower than the top face of the bottom protective part 11c (refer to the lower double-dashed chain line).

In essence, to suppress noise that may generate in the mounting structure shown in FIG. 3, the thickness Tc of the bottom protective part 11c should be sufficient to attenuate the transmitted stress and to absorb the amount of extension/contraction as mentioned earlier, as this contributes to the suppression of noise. Based on the values of noise of samples 1 to 4 shown in FIG. 4, noise can be suppressed to 25 db or less when Tc/H is 0.20 or more, so preferably the thickness Tc of the bottom protective part 11c satisfies the condition of Tc/H>0.20 in the multilayer ceramic capacitor 10-1 shown in FIGS. 1 and 2. Also, based on the values of noise of samples 1 to 4 shown in FIG. 4, increasing the thickness Tc of the bottom protective part 11c as much as possible appears effective in suppressing noise, but if the thickness Tc is increased excessively, the ratio H/W of the height H and width W of the capacitor body 11 increases and it presents concerns such as the multilayer ceramic capacitor 10-1 collapsing easily when being mounted. When the specifications of samples 1 to 4 in FIG. 4 are viewed with this point in mind, an appropriate upper limit of Tc/H is 0.40 as measured on sample 2, indicating that more preferably the thickness Tc of the bottom protective part 11c satisfies the condition of 0.20≦Tc/H≦0.40 in the multilayer ceramic capacitor 10-1 shown in FIGS. 1 and 2.

### <Value Range of Tc/Tb>

Based on the values of noise of samples 1 to 4 shown in FIG. 4, noise can be suppressed to 25 db or less so long as Tc/Tb is 4.6 or more, indicating that preferably the thickness Tb of the top protective part 11b and thickness Tc of the bottom protective part 11c satisfy the condition of Tc/Tb≧4.6. Also, to eliminate the concerns mentioned in the preceding paragraph, an appropriate upper limit of Tc/Tb is 12.8 as measured on sample 2, indicating that more preferably the thickness Tb of the top protective part 11b and thickness Tc of the bottom protective part 11c satisfy the condition of 4.6≦Tc/Tb≦12.6 in the multilayer ceramic capacitor 10-1 shown in FIGS. 1 and 2.

### Second Embodiment

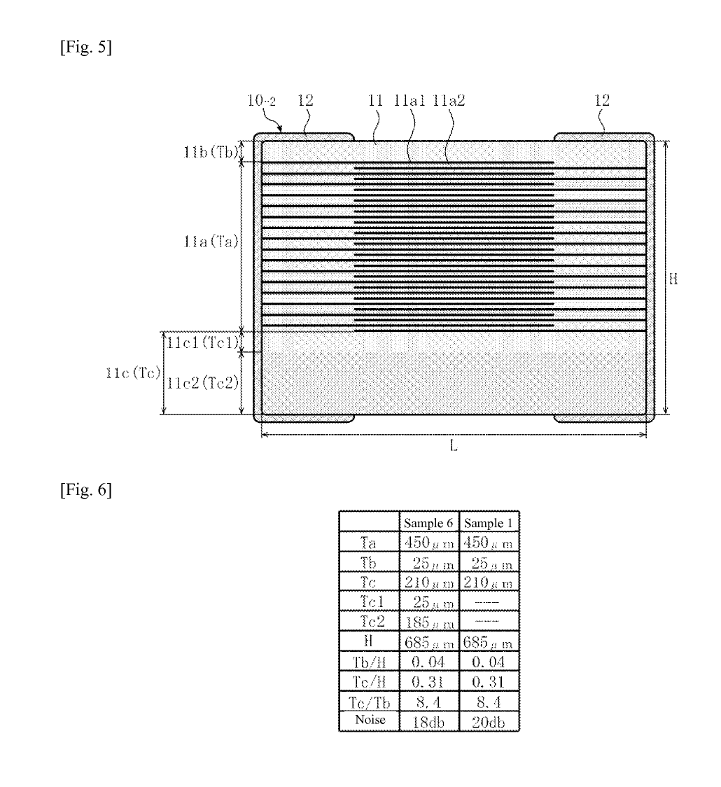

FIG. 5 shows the basic structure of a multilayer ceramic capacitor 10-2 to which the present invention is applied (Second Embodiment). This multilayer ceramic capacitor 10-2 is different from the multilayer ceramic capacitor 10-1 shown in FIGS. 1 and 2 in that (M1) the composition of the top protective part 11b and that of a top part 11c1 of the bottom protective part 11c are the same as the composition of the multiple dielectric layers 11a2 included in the capacitive part 11a, and in that the composition of a bottom part 11c2 of the bottom protective part 11c excluding its top part 11c1 is different from the composition of the multiple dielectric layers 11a2 included in the capacitive part 11a. The thickness Tc1 of the top part 11c1 of the bottom protective part 11c may be the same as the thickness Tb of the top protective part 11b, or it may be smaller or greater than the thickness Tb of the top protective part 11b. Although FIG. 5 shows a total of 32 internal electrode layers 11a1 for the purpose of illustration, the number of internal electrode layers 11a1 is not limited in any way as in the case with the multilayer ceramic capacitor 10-1 shown in FIGS. 1 and 2.

“Same composition” mentioned in the preceding paragraph means the same constituents, and it does not mean the same constituents where each constituent is contained by the same amount. Additionally, “different composition” mentioned in the preceding paragraph means different constituents or the same constituents where each constituent is contained by a different amount. A “different composition” as mentioned in the preceding paragraph can be achieved, for example, by changing the contents or types of the secondary constituents without changing the type of the primary constituent (dielectric ceramic) of the bottom part 11c2 of the bottom protective part 11c, or by changing the type of the primary constituent (dielectric ceramic) of the bottom part 11c2 of the bottom protective part 11c.

On the premise of suppressing noise, preferably the former method mentioned in the preceding paragraph uses, in the bottom part 11c2 of the bottom protective part 11c, a secondary constituent that lowers the dielectric constant of this part, such as at least one type of constituent selected from a group that includes Mg, Ca, Sr, and other alkali earth metal elements, Mn, V, Mo, W, Cr, and other transition metal elements, and La, Ce, Pr, Nd, Sm, Eu, Gd, Tb, Dy, Ho, Er, Tm, Yb, Lu, and other rare earth elements. Under the latter method mentioned in the preceding paragraph, on the other hand, it is desirable to select, as the primary constituent (dielectric ceramic) of the bottom part 11c2 of the bottom protective part 11c, a dielectric ceramic that lowers the dielectric constant of this part. In this case, the dielectric constant of the top protective part 11b and dielectric constant of the top part 11c1 of the bottom protective part 11c become equivalent to the dielectric constant of the multiple dielectric layers 11a2 included in the capacitive part 11a, while the dielectric constant of the bottom part 11c2 of the bottom protective part 11c becomes lower than the dielectric constant of the multiple dielectric layers 11a2 included in the capacitive part 11a.

Here, a favorable example of manufacturing the multilayer ceramic capacitor 10-2 shown in FIG. 5 is presented. If the primary constituent of the multiple internal electrode layers 11a1 included in the capacitive part 11a is nickel, and the primary constituent of the multiple dielectric layers 11a2 included in the capacitive part 11a, top protective part 11b, and bottom protective part 11c is barium titanate, then first of all an internal electrode layer paste containing nickel powder, terpineol (solvent), ethyl cellulose (binder), and dispersant and other additives is prepared, along with a first ceramic slurry containing barium titanate powder, ethanol (solvent), polyvinyl butyral (binder), and dispersant and other additives, as well as a second ceramic slurry comprising the first ceramic slurry with an appropriate amount of MgO added to it.

Then, the first ceramic slurry is coated onto a carrier film and dried, using a die-coater or other coating machine and a drying machine, to produce a first green sheet, while the second ceramic slurry is coated onto a different carrier film and then dried to produce a second green sheet (containing MgO). In addition, the internal electrode layer paste is printed onto the first green sheet in a matrix or zigzag pattern and then dried, using a screen printer or other printing machine and a drying machine, to produce a third green sheet having internal electrode layer patterns formed on it.

Then, unit sheets that have been stamped out of the second green sheet (containing MgO) are stacked until the specified quantity is reached, using a pickup head having stamping blades and heaters or other stacking machine, and then are thermally bonded, to produce a portion corresponding to the bottom part 11c2 of the bottom protective part 11c. Next, unit sheets that have been stamped out of the first green sheet are stacked until the specified quantity is reached and then they are thermally bonded, to produce a portion corresponding to the top part 11c1 of the bottom protective part 11c. Next, unit sheets (including internal electrode layer patterns) that have been stamped out of the third green sheet are stacked until the specified quantity is reached and then they are thermally bonded, to produce a portion corresponding to the capacitive part 11a. Next, unit sheets that have been stamped out of the first green sheet are stacked until the specified quantity is reached and then they are thermally bonded, to produce a portion corresponding to the top protective part 11b. Next, the respective portions are stacked and then thermally bonded one last time, using a hot hydrostatic press or other final bonding machine, to produce an unsintered laminated sheet.

Then, the unsintered laminated sheet is cut into a grid pattern using a dicing machine or other cutting machine, to produce unsintered chips each corresponding to the capacitor body 11. Then, the many unsintered chips are sintered (the process includes both removal of binder and sintering) using a tunnel-type sintering furnace or other sintering machine, in a reducing ambience or ambience of low partial oxygen pressure according to a temperature profile appropriate for nickel and barium titanate, to produce sintered chips.

Then, an electrode paste (the internal electrode layer paste is used) is applied to the respective ends of a sintered chip in its length direction using a roller applicator or other application machine, and then dried and baked in an ambience similar to the one mentioned above to form a base film, on top of which a surface film, or an intermediate film and surface film, is/are formed by means of electroplating or other plating treatment, to produce external electrodes 12. The base film of each external electrode may also be produced by applying the electrode paste to the respective ends of an unsintered chip in its length direction, and drying and then baking the paste simultaneously with the unsintered chip.

Note that a structure constituted by the multilayer ceramic capacitor 10-2 shown in FIG. 5, which is mounted on a circuit board 21, and a favorable example of mounting this structure, are not explained because they are the same as the mounting structure (refer to FIG. 3) and a favorable example of mounting this structure as described in “First Embodiment” above.

FIG. 6 shows the specifications and characteristics of sample 6 prepared to verify the effects obtained by the multilayer ceramic capacitor 10-2 shown in FIG. 5. FIG. 6 also lists the specifications and characteristics of sample 1 shown in FIG. 4 for the purpose of comparison.

Sample 6 shown in FIG. 6, produced according to the aforementioned manufacturing example, has the basic specifications as described below.

### <Basic Specifications of Sample 6>

Sample 6 is the same as sample 1, except that, of the thickness Tc (210 μm) of the bottom protective part 11c, the thickness Tc1 of the top part 11c1 is 25 μm and thickness Tc2 of the bottom part 11c2 is 185 μm, and that the bottom part 11c2 contains Mg.

Note that the methods of calculating the value of Tb/H, value of Tc/H, and value of Tc/Tb, method of measuring the value of noise shown in FIG. 6, and basic specifications of the mounting structure used for measurement, are not explained because they are the same as the calculating methods, measurement method, and basic specifications of mounting structure as described in “First Embodiment” above.

As mentioned earlier, an ideal upper limit of noise is said to be 25 db in general, and therefore sample 6 shown in FIG. 6, representing the multilayer ceramic capacitor 10-2 shown in FIG. 5, is effective in suppressing noise. Needless to say, the value range of Tb/H, value range of Tc/H, and value range of Tc/Tb that are favorable in terms of suppressing noise as described in “First Embodiment” above can also be applied to the multilayer ceramic capacitor 10-2 shown in FIG. 5.

In addition, by adjusting the dielectric constant of the bottom part 11c2 of the bottom protective part 11c to lower than the dielectric constant of the multiple dielectric layers 11a2 included in the capacitive part 11a and that of the top part 11c1 of the bottom protective part 11c, the electric field intensity that generates at the bottom protective part 11c when voltage is applied in a mounted state can be reduced so that the transmitted stress described in “First Embodiment” above is attenuated in a more reliable manner, to contribute to the suppression of noise.

Furthermore, because the composition of the bottom part 11c2 of the bottom protective part 11c is different from the composition of the multiple dielectric layers 11a2 included in the capacitive part 11a, composition of the top protective part 11b or composition of the top part 11c1 of the bottom protective part 11c, the vertical direction of the multilayer ceramic capacitor 10-2 can be easily determined when mounting the capacitor, based on the exterior color of the bottom part 11c2 of the bottom protective part 11c which is different from the other parts.

Note that, while in the aforementioned manufacturing example and with sample 6 the bottom part 11c2 of the bottom protective part 11c contains Mg in order to satisfy the requirement M1 mentioned at the beginning of “Second Embodiment” herein, the bottom part 11c2 may contain one type of constituent selected from a group that includes Ca, Sr, and other alkali earth metal elements other than Mg, or it may contain two or more types of alkali earth metal elements (including Mg), and effects similar to those mentioned above can still be achieved. In addition, the bottom part 11c2 of the bottom protective part 11c may, instead of an alkali earth metal element or elements, contain at least one type of constituent selected from a group that includes Mn, V, Mo, W, Cr, and other transition metal elements, or it may contain at least one type of constituent selected from a group that includes La, Ce, Pr, Nd, Sm, Eu, Gd, Tb, Dy, Ho, Er, Tm, Yb, Lu, and other rare earth elements, and effects similar to those mentioned above can still be achieved. In other words, effects similar to those mentioned above can be achieved so long as the bottom part 11c2 of the bottom protective part 11c contains at least one type of constituent selected from a group that includes the aforementioned alkali earth metal elements, transition metal elements, and rare earth elements. Needless to say, when the multiple dielectric layers 11a2 included in the capacitive part 11a, top protective part 11b, and top part 11c1 of the bottom protective part 11c contain at least one type of constituent selected from a group that includes the aforementioned alkali earth metal elements, transition metal elements, and rare earth elements, then effects similar to those mentioned above can be achieved by allowing such constituent or constituents to be contained more in the bottom part 11c2 of the bottom protective part 11c. Furthermore, effects similar to those mentioned above can also be achieved by making the type of the primary constituent (dielectric ceramic) of the bottom part 11c2 of the bottom protective part 11c different from that of the primary constituent (dielectric ceramic) of the multiple dielectric layers 11a2 included in the capacitive part 11a and of the top protective part 11b and top part 11c1 of the bottom protective part 11c in order to satisfy the requirement M1 mentioned at the beginning of “Second Embodiment” herein.

### Third Embodiment

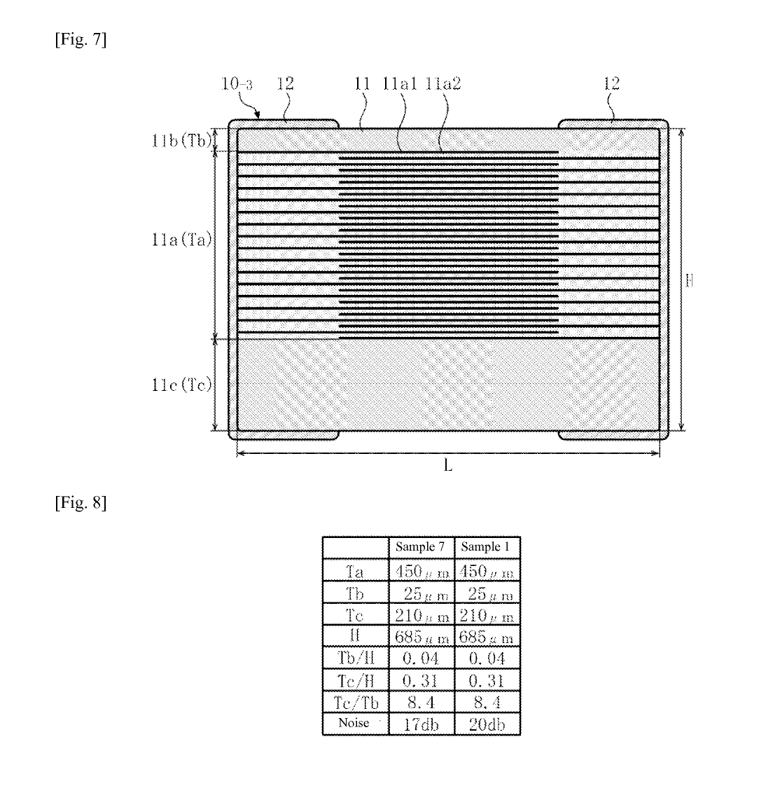

FIG. 7 shows the basic structure of a multilayer ceramic capacitor 10-3 to which the present invention is applied (Third Embodiment). This multilayer ceramic capacitor 10-3 is different from the multilayer ceramic capacitor 10-1 shown in FIGS. 1 and 2 in that (M2) the composition of the top protective part 11b is the same as the composition of the bottom protective part 11c, and in that the composition of the top protective part 11b and that of the bottom protective part 11c are different from the composition of the multiple dielectric layers 11a2 included in the capacitive part 11a. Although FIG. 7 shows a total of 32 internal electrode layers 11a1 for the purpose of illustration, the number of internal electrode layers 11a1 is not limited in any way as in the case with the multilayer ceramic capacitor 10-1 shown in FIGS. 1 and 2.

“Same composition” mentioned in the preceding paragraph means the same constituents, and it does not mean the same constituents where each constituent is contained by the same amount. Additionally, “different composition” mentioned in the preceding paragraph means different constituents or the same constituents where each constituent is contained by a different amount. A “different composition” as mentioned in the preceding paragraph can be achieved, for example, by changing the contents or types of the secondary constituents without changing the type of the primary constituent (dielectric ceramic) of the top protective part 11b and bottom protective part 11c, or by changing the type of the primary constituent (dielectric ceramic) of the top protective part 11b and bottom protective part 11c.

On the premise of suppressing noise, preferably the former method mentioned in the preceding paragraph uses, in the top protective part 11b and bottom protective part 11c, a secondary constituent that lowers the dielectric constants of these parts, such as at least one type of constituent selected from a group that includes Mg, Ca, Sr, and other alkali earth metal elements, Mn, V, Mo, W, Cr, and other transition metal elements, and La, Ce, Pr, Nd, Sm, Eu, Gd, Tb, Dy, Ho, Er, Tm, Yb, Lu, and other rare earth elements. Under the latter method mentioned in the preceding paragraph, on the other hand, it is desirable to select, as the primary constituent (dielectric ceramic) of the top protective part 11b and bottom protective part 11c, a dielectric ceramic that lowers the dielectric constants of these parts. In this case, the dielectric constant of the top protective part 11b becomes equivalent to the dielectric constant of the bottom protective part 11c, while the dielectric constant of the top protective part 11b and that of the bottom protective part 11c become lower than the dielectric constant of the multiple dielectric layers 11a2 included in the capacitive part 11a.

Here, a favorable example of manufacturing the multilayer ceramic capacitor 10-3 shown in FIG. 7 is presented. If the primary constituent of the multiple internal electrode layers 11a1 included in the capacitive part 11a is nickel, and the primary constituent of the multiple dielectric layers 11a2 included in the capacitive part 11a, top protective part 11b and bottom protective part 11c is barium titanate, then first of all an internal electrode layer paste containing nickel powder, terpineol (solvent), ethyl cellulose (binder), and dispersant and other additives is prepared, along with a first ceramic slurry containing barium titanate powder, ethanol (solvent), polyvinyl butyral (binder), and dispersant and other additives, as well as a second ceramic slurry comprising the first ceramic slurry with an appropriate amount of MgO added to it.

Then, the first ceramic slurry is coated onto a carrier film and dried, using a die-coater or other coating machine and a drying machine, to produce a first green sheet, while the second ceramic slurry is coated onto a different carrier film and then dried to produce a second green sheet (containing MgO). In addition, the internal electrode layer paste is printed onto the first green sheet in a matrix or zigzag pattern and then dried, using a screen printer or other printing machine and a drying machine, to produce a third green sheet having internal electrode layer patterns formed on it, while the internal electrode layer paste is printed onto the second green sheet (containing MgO) in a matrix or zigzag pattern and then dried to produce a fourth green sheet (containing MgO) having internal electrode layer patterns formed on it.

Then, unit sheets that have been stamped out of the second green sheet (containing MgO) are stacked until the specified quantity is reached, using a pickup head having stamping blades and heaters or other stacking machine, and then are thermally bonded, to produce a portion corresponding to the bottom protective part 11c. Next, unit sheets (including internal electrode layer patterns) that have been stamped out of the third green sheet are stacked until the specified quantity is reached, on unit sheets (including internal electrode layer patterns) that have been stamped out of the fourth green sheet (containing MgO), and then they are thermally bonded, to produce a portion corresponding to the capacitive part 11a. Next, unit sheets that have been stamped out of the second green sheet (containing MgO) are stacked until the specified quantity is reached and then they are thermally bonded, to produce a portion corresponding to the top protective part 11b. Next, the respective portions are stacked and then thermally bonded one last time, using a hot hydrostatic press or other final bonding machine, to produce an unsintered laminated sheet.

Then, the unsintered laminated sheet is cut into a grid pattern using a dicing machine or other cutting machine, to produce unsintered chips each corresponding to the capacitor body 11. Then, the many unsintered chips are sintered (the process includes both removal of binder and sintering) using a tunnel-type sintering furnace or other sintering machine, in a reducing ambience or ambience of low partial oxygen pressure according to a temperature profile appropriate for nickel and barium titanate, to produce sintered chips.

Then, an electrode paste (the internal electrode layer paste is used) is applied to the respective ends of a sintered chip in its length direction using a roller applicator or other application machine, and then dried and baked in an ambience similar to the one mentioned above to form a base film, on top of which a surface film, or an intermediate film and surface film, is/are formed by means of electroplating or other plating treatment, to produce external electrodes 12. The base film of each external electrode may also be produced by applying the electrode paste to the respective ends of an unsintered chip in its length direction, and drying and then baking the paste simultaneously with the unsintered chip.

Note that a structure constituted by the multilayer ceramic capacitor 10-3 shown in FIG. 7, which is mounted on a circuit board 21, and a favorable example of mounting this structure, are not explained because they are the same as the mounting structure (refer to FIG. 3) and favorable example of mounting this structure as described in “First Embodiment” above.

FIG. 8 shows the specifications and characteristics of sample 7 prepared to verify the effects obtained by the multilayer ceramic capacitor 10-3 shown in FIG. 7. FIG. 8 also lists the specifications and characteristics of sample 1 shown in FIG. 4 for the purpose of comparison.

Sample 7 shown in FIG. 8, produced according to the aforementioned manufacturing example, has the basic specifications as described below.

### <Basic Specifications of Sample 7>

Sample 7 is the same as sample 1, except that the top protective part 11b and bottom protective part 11c contain Mg.

Note that the methods of calculating the value of Tb/H, value of Tc/H, and value of Tc/Tb, method of measuring the value of noise shown in FIG. 8, and basic specifications of the mounting structure used for measurement, are not explained because they are the same as the calculating methods, measurement method, and basic specifications of mounting structure as described in “First Embodiment” above.

As mentioned earlier, an ideal upper limit of noise is said to be 25 db in general, and therefore sample 7 shown in FIG. 8, representing the multilayer ceramic capacitor 10-3 shown in FIG. 7, is effective in suppressing noise. Needless to say, the value range of Tb/H, value range of Tc/H, and value range of Tc/Tb that are favorable in terms of suppressing noise as described in “First Embodiment” above can also be applied to the multilayer ceramic capacitor 10-3 shown in FIG. 7.

In addition, by adjusting the dielectric constant of the bottom protective part 11c to lower than the dielectric constant of the multiple dielectric layers 11a2 included in the capacitive part 11a, the electric field intensity that generates at the bottom protective part 11c when voltage is applied in a mounted state can be reduced so that the transmitted stress described in “First Embodiment” above is attenuated in a more reliable manner, to contribute to the suppression of noise.

Furthermore, because the composition of the top protective part 11b and that of the bottom protective part 11c are different from the composition of the multiple dielectric layers 11a2 included in the capacitive part 11a, and also because the thickness Tc of the bottom protective part 11c is greater than the thickness Tb of the top protective part 11b, the vertical direction of the multilayer ceramic capacitor 10-3 can be easily determined when mounting the capacitor, based on the exterior color of the top protective part 11b and bottom protective part 11c which is different from the other parts and also based on the thickness Tc of the bottom protective part 11c.

Note that, while in the aforementioned manufacturing example and with sample 7 the top protective part 11b and bottom protective part 11c contain Mg in order to satisfy the requirement M2 mentioned at the beginning of “Third Embodiment” herein, the top protective part 11b and bottom protective part 11c may contain one type of constituent selected from a group that includes Ca, Sr, and other alkali earth metal elements other than Mg, or they may contain two or more types of alkali earth metal elements (including Mg), and effects similar to those mentioned above can still be achieved. In addition, the top protective part 11b and bottom protective part 11c may, instead of an alkali earth metal element or elements, contain at least one type of constituent selected from a group that includes Mn, V, Mo, W, Cr, and other transition metal elements, or they may contain at least one type of constituent selected from a group that includes La, Ce, Pr, Nd, Sm, Eu, Gd, Tb, Dy, Ho, Er, Tm, Yb, Lu, and other rare earth elements, and effects similar to those mentioned above can still be achieved. In other words, effects similar to those mentioned above can be achieved so long as the top protective part 11b and bottom protective part 11c contain at least one type of constituent selected from a group that includes the aforementioned alkali earth metal elements, transition metal elements, and rare earth elements. Needless to say, when the multiple dielectric layers 11a2 included in the capacitive part 11a contain at least one type of constituent selected from a group that includes the aforementioned alkali earth metal elements, transition metal elements, and rare earth elements, then effects similar to those mentioned above can be achieved by allowing such constituent or constituents to be contained more in the top protective part 11b and bottom protective part 11c. Furthermore, effects similar to those mentioned above can also be achieved by making the type of the primary constituent (dielectric ceramic) of the top protective part 11b and bottom protective part 11c different from that of the primary constituent (dielectric ceramic) of the multiple dielectric layers 11a2 included in the capacitive part 11a in order to satisfy the requirement M2 mentioned at the beginning of “Third Embodiment” herein.

### Fourth Embodiment

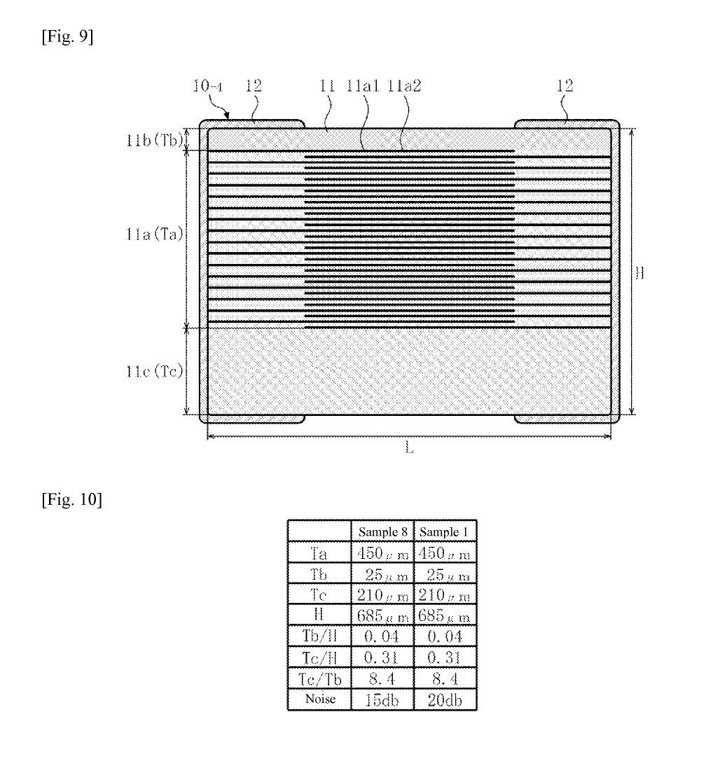

FIG. 9 shows the basic structure of a multilayer ceramic capacitor 10-4 to which the present invention is applied (Fourth Embodiment). This multilayer ceramic capacitor 10-4 is different from the multilayer ceramic capacitor 10-1 shown in FIGS. 1 and 2 in that (M3) the composition of the top protective part 11b is different from the composition of the bottom protective part 11c, and that the composition of the top protective part 11b and that of the bottom protective part 11c are also different from the composition of the multiple dielectric layers 11a2 included in the capacitive part 11a. Although FIG. 9 shows a total of 32 internal electrode layers 11a1 for the purpose of illustration, the number of internal electrode layers 11a1 is not limited in any way as in the case with the multilayer ceramic capacitor 10-1 shown in FIGS. 1 and 2.

“Different composition” mentioned in the preceding paragraph means different constituents or the same constituents where each constituent is contained by a different amount. A “different composition” as mentioned in the preceding paragraph can be achieved, for example, by changing the contents or types of the secondary constituents without changing the type of the primary constituent (dielectric ceramic) of the top protective part 11b and bottom protective part 11c, or by changing the type of the primary constituent (dielectric ceramic) of the top protective part 11b and bottom protective part 11c.

On the premise of suppressing noise, preferably the former method mentioned in the preceding paragraph uses, in the top protective part 11b and bottom protective part 11c, a secondary constituent that lowers the dielectric constants of these parts, such as at least one type of constituent selected from a group that includes Mg, Ca, Sr, and other alkali earth metal elements, Mn, V, Mo, W, Cr, and other transition metal elements, and La, Ce, Pr, Nd, Sm, Eu, Gd, Tb, Dy, Ho, Er, Tm, Yb, Lu, and other rare earth elements, with such constituent contained more in the bottom protective part 11c than in the top protective part 11b. Under the latter method mentioned in the preceding paragraph, on the other hand, it is desirable to select, as the primary constituents (dielectric ceramics) of the top protective part 11b and bottom protective part 11c, two types of dielectric ceramics that lower the dielectric constants of these parts. In this case, the dielectric constant of the top protective part 11b and that of the bottom protective part 11c become lower than the dielectric constant of the multiple dielectric layers 11a2 included in the capacitive part 11a, while the dielectric constant of the bottom protective part 11c becomes lower than the dielectric constant of the top protective part 11b.

Here, a favorable example of manufacturing the multilayer ceramic capacitor 10-4 shown in FIG. 9 is presented. If the primary constituent of the multiple internal electrode layers 11a1 included in the capacitive part 11a is nickel, and the primary constituent of the multiple dielectric layers 11a2 included in the capacitive part 11a, top protective part 11b, and bottom protective part 11c is barium titanate, then first of all an internal electrode layer paste containing nickel powder, terpineol (solvent), ethyl cellulose (binder), and dispersant and other additives is prepared, along with a first ceramic slurry containing barium titanate powder, ethanol (solvent), polyvinyl butyral (binder), and dispersant and other additives, a second ceramic slurry comprising the first ceramic slurry with an appropriate amount of MgO added to it, and a third ceramic slurry comprising the first ceramic slurry with a little more MgO than in the second ceramic slurry added to it.

Then, the first ceramic slurry is coated onto a carrier film and dried, using a die-coater or other coating machine and a drying machine, to produce a first green sheet, the second ceramic slurry is coated onto a different carrier film and then dried to produce a second green sheet (containing MgO), and the third ceramic slurry is coated onto a different carrier film and then dried to produce a third green sheet (containing MgO). In addition, the internal electrode layer paste is printed onto the first green sheet in a matrix or zigzag pattern and then dried, using a screen printer or other printing machine and a drying machine, to produce a fourth green sheet having internal electrode layer patterns formed on it, while the internal electrode layer paste is printed onto the third green sheet (containing MgO) in a matrix or zigzag pattern and then dried to produce a fifth green sheet (containing MgO) having internal electrode layer patterns formed on it.

Then, unit sheets that have been stamped out of the third green sheet (containing MgO) are stacked until the specified quantity is reached, using a pickup head having stamping blades and heaters or other stacking machine, and then are thermally bonded, to produce a portion corresponding to the bottom protective part 11c. Next, unit sheets (including internal electrode layer patterns) that have been stamped out of the fourth green sheet are stacked until the specified quantity is reached, on unit sheets (including internal electrode layer patterns) that have been stamped out of the fifth green sheet (containing MgO), and then they are thermally bonded, to produce a portion corresponding to the capacitive part 11a. Next, unit sheets that have been stamped out of the second green sheet (containing MgO) are stacked until the specified quantity is reached and then they are thermally bonded, to produce a portion corresponding to the top protective part 11b. Next, the respective portions are stacked and then thermally bonded one last time, using a hot hydrostatic press or other final bonding machine, to produce an unsintered laminated sheet.

Then, the unsintered laminated sheet is cut into a grid pattern using a dicing machine or other cutting machine, to produce unsintered chips each corresponding to the capacitor body 11. Then, the many unsintered chips are sintered (the process includes both removal of binder and sintering) using a tunnel-type sintering furnace or other sintering machine, in a reducing ambience or ambience of low partial oxygen pressure according to a temperature profile appropriate for nickel and barium titanate, to produce sintered chips.

Then, an electrode paste (the internal electrode layer paste is used) is applied to the respective ends of a sintered chip in its length direction using a roller applicator or other application machine, and then dried and baked in an ambience similar to the one mentioned above to form a base film, on top of which a surface film, or an intermediate film and surface film, is/are formed by means of electroplating or other plating treatment, to produce external electrodes 12. The base film of each external electrode may also be produced by applying the electrode paste to the respective ends of an unsintered chip in its length direction, and drying and then baking the paste simultaneously with the unsintered chip.

Note that a structure constituted by the multilayer ceramic capacitor 10-4 shown in FIG. 9, being mounted on a circuit board 21, and a favorable example of mounting this structure, are not explained because they are the same as the mounting structure (refer to FIG. 3) and favorable example of mounting this structure as described in “First Embodiment” above.

FIG. 10 shows the specifications and characteristics of sample 8 prepared to verify the effects obtained by the multilayer ceramic capacitor 10-4 shown in FIG. 9. FIG. 10 also lists the specifications and characteristics of sample 1 shown in FIG. 4 for the purpose of comparison.

Sample 8 shown in FIG. 10, produced according to the aforementioned manufacturing example, has the basic specifications as described below.

### <Basic Specifications of Sample 8>

Sample 8 is the same as sample 1, except that the top protective part 11b and bottom protective part 11c contain Mg, and that the Mg content in the bottom protective part 11c is greater than the Mg content in the top protective part 11b.

Note that the methods of calculating the value of Tb/H, value of Tc/H, and value of Tc/Tb, method of measuring the value of noise shown in FIG. 10, and basic specifications of the mounting structure used for measurement, are not explained because they are the same as the calculating methods, measurement method, and basic specifications of mounting structure as described in “First Embodiment” above.

As mentioned earlier, an ideal upper limit of noise is said to be 25 db in general, and therefore sample 8 shown in FIG. 10, representing the multilayer ceramic capacitor 10-4 shown in FIG. 9, is effective in suppressing noise. Needless to say, the value range of Tb/H, value range of Tc/H, and value range of Tc/Tb that are favorable in terms of suppressing noise as described in “First Embodiment” above can also be applied to the multilayer ceramic capacitor 10-4 shown in FIG. 9.

In addition, by adjusting the dielectric constant of the bottom protective part 11c to lower than the dielectric constant of the multiple dielectric layers 11a2 included in the capacitive part 11a, the electric field intensity that generates at the bottom protective part 11c when voltage is applied in a mounted state can be reduced so that the transmitted stress described in “First Embodiment” above is attenuated in a more reliable manner, to contribute to the suppression of noise.

Furthermore, because the composition of the top protective part 11b and that of the bottom protective part 11c are different from the composition of the multiple dielectric layers 11a2 included in the capacitive part 11a, and also because the thickness Tc of the bottom protective part 11c is greater than the thickness Tb of the top protective part 11b, the vertical direction of the multilayer ceramic capacitor 10-4 can be easily determined when mounting the capacitor, based on the exterior color of the top protective part 11b and bottom protective part 11c which is different from the other parts and also based on the thickness Tc of the bottom protective part 11c.

Note that, while in the aforementioned manufacturing example and with sample 8 the top protective part 11b and bottom protective part 11c contain Mg in order to satisfy the requirement M3 mentioned at the beginning of “Fourth Embodiment” herein, the top protective part 11b and bottom protective part 11c may contain one type of constituent selected from a group that includes Ca, Sr, and other alkali earth metal elements other than Mg, or they may contain two or more types of alkali earth metal elements (including Mg), and effects similar to those mentioned above can still be achieved. In addition, the top protective part 11b and bottom protective part 11c may, instead of an alkali earth metal element or elements, contain at least one type of constituent selected from a group that includes Mn, V, Mo, W, Cr, and other transition metal elements, or they may contain at least one type of constituent selected from a group that includes La, Ce, Pr, Nd, Sm, Eu, Gd, Tb, Dy, Ho, Er, Tm, Yb, Lu, and other rare earth elements, and effects similar to those mentioned above can still be achieved. In other words, effects similar to those mentioned above can be achieved so long as the top protective part 11b and bottom protective part 11c contain at least one type of constituent selected from a group that includes the aforementioned alkali earth metal elements, transition metal elements, and rare earth elements. Needless to say, when the multiple dielectric layers 11a2 included in the capacitive part 11a contain at least one type of constituent selected from a group that includes the aforementioned alkali earth metal elements, transition metal elements, and rare earth elements, then effects similar to those mentioned above can be achieved by allowing such constituent or constituents to be contained more in the top protective part 11b and bottom protective part 11c. Furthermore, effects similar to those mentioned above can also be achieved by making the type of the primary constituent (dielectric ceramic) of the top protective part 11b and bottom protective part 11c different from that of the primary constituent (dielectric ceramic) of the multiple dielectric layers 11a2 included in the capacitive part 11a in order to satisfy the requirement M3 mentioned at the beginning of “Fourth Embodiment” herein.

### Fifth Embodiment

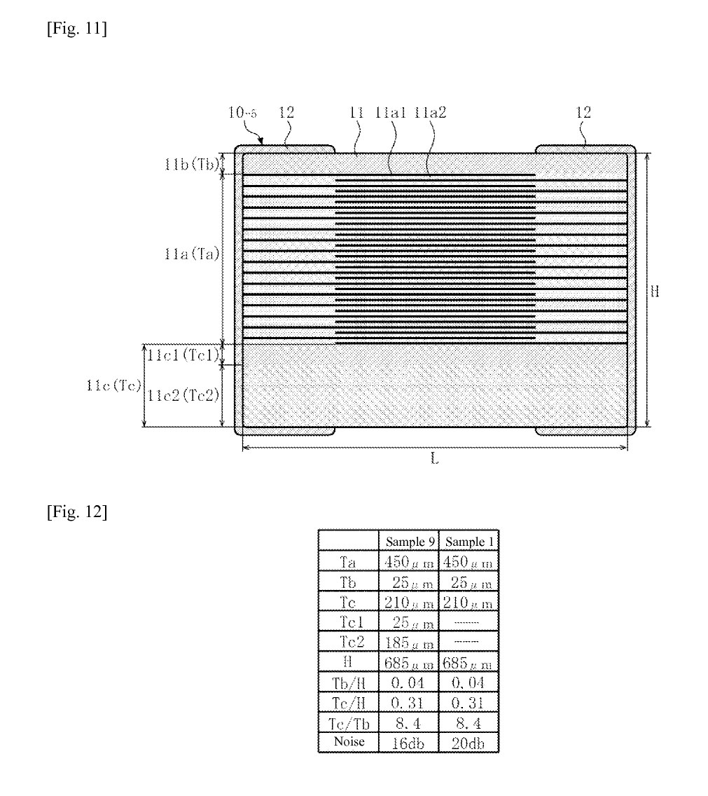

FIG. 11 shows the basic structure of a multilayer ceramic capacitor 10-5 to which the present invention is applied (Fifth Embodiment). This multilayer ceramic capacitor 10-5 is different from the multilayer ceramic capacitor 10-1 shown in FIGS. 1 and 2 in that (M4) the composition of the top protective part 11b is the same as the composition of the top part 11c1 of the bottom protective part 11c, in that the composition of the top protective part 11b and that of the top part 11c1 of the bottom protective part 11c are different from the composition of the multiple dielectric layers 11a2 included in the capacitive part 11a, and in that the composition of the bottom part 11c2 of the bottom protective part 11c excluding its top part 11c1 is also different from the composition of the top protective part 11b, that of the top part 11c1 of the bottom protective part 11c and that of the multiple dielectric layers 11a2 included in the capacitive part 11a. Although FIG. 11 shows a total of 32 internal electrode layers 11a1 for the purpose of illustration, the number of internal electrode layers 11a1 is not limited in any way as in the case with the multilayer ceramic capacitor 10-1 shown in FIGS. 1 and 2.

“Different composition” mentioned in the preceding paragraph means different constituents or the same constituents where each constituent is contained by a different amount. A “different composition” as mentioned in the preceding paragraph can be achieved, for example, by changing the contents or types of the secondary constituents without changing the type of the primary constituent (dielectric ceramic) of the top protective part 11b and bottom protective part 11c, or by changing the type of the primary constituent (dielectric ceramic) of the top protective part 11b and bottom protective part 11c.

On the premise of suppressing noise, preferably the former method mentioned in the preceding paragraph uses, in the top protective part 11b and the top part 11c1 and bottom part 11c2 of the bottom protective part 11c, a secondary constituent that lowers the dielectric constants of these parts, such as at least one type of constituent selected from a group that includes Mg, Ca, Sr, and other alkali earth metal elements, Mn, V, Mo, W, Cr, and other transition metal elements, and La, Ce, Pr, Nd, Sm, Eu, Gd, Tb, Dy, Ho, Er, Tm, Yb, Lu, and other rare earth elements, with such constituent contained more in the bottom part 11c2 of the bottom protective part 11c than in the top protective part 11b or in the top part 11c1 of the bottom protective part 11c. Under the latter method mentioned in the preceding paragraph, on the other hand, it is desirable to select, as the primary constituents (dielectric ceramics) of the top protective part 11b and the top part 11c1 and bottom part 11c2 of the bottom protective part 11c, two types of dielectric ceramics that lower the dielectric constants of these parts. In this case, the dielectric constant of the top protective part 11b becomes equivalent to the dielectric constant of the top part 11c1 of the bottom protective part 11c, the dielectric constant of the top protective part 11b and that of the top part 11c1 of the bottom protective part 11c become lower than the dielectric constant of the multiple dielectric layers 11a2 included in the capacitive part 11a, and the dielectric constant of the bottom part 11c2 of the bottom protective part 11c becomes lower than the dielectric constant of the top protective part 11b and that of the top part 11c1 of the bottom protective part 11c.

Here, a favorable example of manufacturing the multilayer ceramic capacitor 10-5 shown in FIG. 11 is presented. If the primary constituent of the multiple internal electrode layers 11a1 included in the capacitive part 11a is nickel, and the primary constituent of the multiple dielectric layers 11a2 included in the capacitive part 11a, top protective part 11b, and bottom protective part 11c is barium titanate, then first of all an internal electrode layer paste containing nickel powder, terpineol (solvent), ethyl cellulose (binder), and dispersant and other additives is prepared, along with a first ceramic slurry containing barium titanate powder, ethanol (solvent), polyvinyl butyral (binder), and dispersant and other additives, a second ceramic slurry comprising the first ceramic slurry with an appropriate amount of MgO added to it, and a third ceramic slurry comprising the first ceramic slurry with a little more MgO than in the second ceramic slurry added to it.

Then, the first ceramic slurry is coated onto a carrier film and dried, using a die-coater or other coating machine and a drying machine, to produce a first green sheet, the second ceramic slurry is coated onto a different carrier film and then dried to produce a second green sheet (containing MgO), and the third ceramic slurry is coated onto a different carrier film and then dried to produce a third green sheet (containing MgO). In addition, the internal electrode layer paste is printed onto the first green sheet in a matrix or zigzag pattern and then dried, using a screen printer or other printing machine and a drying machine, to produce a fourth green sheet having internal electrode layer patterns formed on it, while the internal electrode layer paste is printed onto the second green sheet (containing MgO) in a matrix or zigzag pattern and then dried to produce a fifth green sheet (containing MgO) having internal electrode layer patterns formed on it.

Then, unit sheets that have been stamped out of the third green sheet (containing MgO) are stacked until the specified quantity is reached, using a pickup head having stamping blades and heaters or other stacking machine, and then are thermally bonded, to produce a portion corresponding to the bottom part 11c2 of the bottom protective part 11c. Next, units sheets that have been stamped out of the second green sheet (containing MgO) are stacked until the specified quantity is reached and then they are thermally bonded, to produce a portion corresponding to the top part 11c1 of the bottom protective part 11c. Next, unit sheets (including internal electrode layer patterns) that have been stamped out of the fourth green sheet are stacked until the specified quantity is reached, on unit sheets (including internal electrode layer patterns) that have been stamped out of the fifth green sheet (containing MgO), and then they are thermally bonded, to produce a portion corresponding to the capacitive part 11a. Next, unit sheets that have been stamped out of the second green sheet (containing MgO) are stacked until the specified quantity is reached and then they are thermally bonded, to produce a portion corresponding to the top protective part 11b. Next, the respective portions are stacked and then thermally bonded one last time, using a hot hydrostatic press or other final bonding machine, to produce an unsintered laminated sheet.

Then, the unsintered laminated sheet is cut to a grid pattern using a dicing machine or other cutting machine, to produce unsintered chips each corresponding to the capacitor body 11. Then, the many unsintered chips are sintered (the process includes both removal of binder and sintering) using a tunnel-type sintering furnace or other sintering machine, in a reducing ambience or ambience of low partial oxygen pressure according to a temperature profile appropriate for nickel and barium titanate, to produce sintered chips.

Then, an electrode paste (the internal electrode layer paste is used) is applied to the respective ends of a sintered chip in its length direction using a roller applicator or other application machine, and then dried and baked in an ambience similar to the one mentioned above to form a base film, on top of which a surface film, or an intermediate film and surface film, is/are formed by means of electroplating or other plating treatment, to produce external electrodes 12. The base film of each external electrode may also be produced by applying the electrode paste to the respective ends of an unsintered chip in its length direction, and drying and then baking the paste simultaneously with the unsintered chip.

Note that a structure constituted by the multilayer ceramic capacitor 10-5 shown in FIG. 11, which is mounted on a circuit board 21, and a favorable example of mounting this structure, are not explained because they are the same as the mounting structure (refer to FIG. 3) and favorable example of mounting this structure as described in “First Embodiment” above.

FIG. 12 shows the specifications and characteristics of sample 9 prepared to verify the effects obtained by the multilayer ceramic capacitor 10-5 shown in FIG. 11. FIG. 12 also lists the specifications and characteristics of sample 1 shown in FIG. 4 for the purpose of comparison.

Sample 9 shown in FIG. 12, produced according to the aforementioned manufacturing example, has the basic specifications as described below.

### <Basic Specifications of Sample 9>

Sample 9 is the same as sample 1, except that, of the thickness Tc (210 μm) of the bottom protective part 11c, the thickness Tc1 of the top part 11c1 is 25 μm and thickness Tc2 of the bottom part 11c2 is 185 μm, and that these top part 11c1 and bottom part 11c2 as well as top protective part 11b contain Mg, and the Mg content in the bottom part 11c2 of the bottom protective part 11c is greater than the Mg content in the top protective part 11b or in the top part 11c1 of the bottom protective part 11c.

Note that the methods of calculating the value of Tb/H, value of Tc/H, and value of Tc/Tb, method of measuring the value of noise shown in FIG. 12, and basic specifications of the mounting structure used for measurement, are not explained because they are the same as the calculating methods, measurement method, and basic specifications of mounting structure as described in “First Embodiment” above.

As mentioned earlier, an ideal upper limit of noise is said to be 25 db in general, and therefore sample 9 shown in FIG. 12, representing the multilayer ceramic capacitor 10-5 shown in FIG. 11, is effective in suppressing noise. Needless to say, the value range of Tb/H, value range of Tc/H, and value range of Tc/Tb that are favorable in terms of suppressing noise as described in “First Embodiment” above can also be applied to the multilayer ceramic capacitor 10-5 shown in FIG. 11.

In addition, by adjusting the dielectric constant of the top protective part 11b and that of the top part 11c1 of the bottom protective part 11c to lower than the dielectric constant of the multiple dielectric layers 11a2 included in the capacitive part 11a, and also by adjusting the dielectric constant of the bottom part 11c2 of the bottom protective part 11c to lower than the dielectric constant of the top part 11c1 of the bottom protective part 11c, the electric field intensity that generates at the bottom protective part 11c when voltage is applied in a mounted state can be reduced so that the transmitted stress described in “First Embodiment” above is attenuated in a more reliable manner, to contribute to the suppression of noise.

Furthermore, because the composition of the top protective part 11b, that of the top part 11c1 of the bottom protective part 11c, and that of the bottom part 11c2 of the bottom protective part 11c are different from the composition of the multiple dielectric layers 11a2 included in the capacitive part 11a, and also because the thickness Tc of the bottom protective part 11c is greater than the thickness Tb of the top protective part 11b, the vertical direction of the multilayer ceramic capacitor 10-5 can be easily determined when mounting the capacitor, based on the exterior color of the top protective part 11b and bottom protective part 11c which is different from the other parts and also based on the thickness Tc of the bottom protective part 11c.

Note that, while in the aforementioned manufacturing example and with sample 9 the top protective part 11b, top part 11c1 of the bottom protective part 11c and bottom part 11c2 of the bottom protective part 11c contain Mg in order to satisfy the requirement M4 mentioned at the beginning of “Fifth Embodiment” herein, the top protective part 11b, top part 11c1 of the bottom protective part 11c and bottom part 11c2 of the bottom protective part 11c may contain one type of constituent selected from a group that includes Ca, Sr, and other alkali earth metal elements other than Mg, or they may contain two or more types of alkali earth metal elements (including Mg), and effects similar to those mentioned above can still be achieved. In addition, the top protective part 11b, top part 11c1 of the bottom protective part 11c, and bottom part 11c2 of the bottom protective part 11c may, instead of an alkali earth metal element or elements, contain at least one type of constituent selected from a group that includes Mn, V, Mo, W, Cr, and other transition metal elements, or they may contain at least one type of constituent selected from a group that includes La, Ce, Pr, Nd, Sm, Eu, Gd, Tb, Dy, Ho, Er, Tm, Yb, Lu, and other rare earth elements, and effects similar to those mentioned above can still be achieved. In other words, effects similar to those mentioned above can be achieved so long as the top protective part 11b, top part 11c1 of the bottom protective part 11c, and bottom part 11c2 of the bottom protective part 11c contain at least one type of constituent selected from a group that includes the aforementioned alkali earth metal elements, transition metal elements, and rare earth elements. Needless to say, when the multiple dielectric layers 11a2 included in the capacitive part 11a contain at least one type of constituent selected from a group that includes the aforementioned alkali earth metal elements, transition metal elements, and rare earth elements, then effects similar to those mentioned above can be achieved by allowing such constituent or constituents to be contained more in the top protective part 11b, top part 11c1 of the bottom protective part 11c, and bottom part 11c2 of the bottom protective part 11c. Furthermore, effects similar to those mentioned above can also be achieved by making the type of the primary constituent (dielectric ceramic) of the top protective part 11b, top part 11c1 of the bottom protective part 11c, and bottom part 11c2 of the bottom protective part 11c different from that of the primary constituent (dielectric ceramic) of the multiple dielectric layers 11a2 included in the capacitive part 11a in order to satisfy the requirement M4 mentioned at the beginning of “Fifth Embodiment” herein.

### Other Embodiments

(1) “First Embodiment” through “Fifth Embodiment” illustrated multilayer ceramic capacitors 10-1 to 10-5 whose capacitor body 11 has the height H larger than its width W, but if the thickness Ta of the capacitive part 11a can be decreased, the capacitive part 11a can be disproportionately positioned in the upper side of the capacitor body 11 in its height direction by making the thickness Tc of the bottom protective part 11c greater than the thickness Tb of the top protective part 11b, even when the height H of the capacitor body is the same as its width W or when the height H of the capacitor body is smaller than its width W.

(2) “Second Embodiment” and “Fifth Embodiment” illustrated cases where a dielectric ceramic is the primary constituent of the bottom part 11c2 of the bottom protective layer 11c in the capacitor body 11, but the bottom part 11c2 may be formed by, for example, Li—Si, B—Si, Li—Si—Ba or B—Si—Ba glass, any such glass in which silica, alumina, or other filler is dispersed, or epoxy resin, polyimide, or other thermosetting plastic. In this case, the same methods described in the manufacturing examples of “Second Embodiment” and “Fifth Embodiment,” except that an unsintered laminated sheet without the bottom part 11c2 of the bottom protective layer 11c is produced in the unsintered laminated sheet process and thereafter a sheet-shaped part in place of the bottom part 11c2 is pasted using adhesive, etc., can be adopted favorably.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, an article “a” or “an” may refer to a species or a genus including multiple species, and “the invention” or “the present invention” may refer to at least one of the embodiments or aspects explicitly, necessarily, or inherently disclosed herein. The terms “constituted by” and “having” refer independently to “typically or broadly comprising”, “comprising”, “consisting essentially of”, or “consisting of” in some embodiments. In this disclosure, any defined meanings do not necessarily exclude ordinary and customary meanings in some embodiments.

The present application claims priorities to Japanese Patent Application No. 2013-179361, filed Aug. 30, 2013, and No. 2014-153566, filed Jul. 29, 2014, each disclosure of which is herein incorporated by reference in its entirety, including any and all particular combinations of the features disclosed therein, for some embodiments.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. A multilayer ceramic capacitor having a capacitor body of roughly rectangular solid shape specified by a certain length, width, and height, as well as external electrodes provided on respective ends of the capacitor body in its length direction, wherein:
the capacitor body integrally has a capacitive part constituted by multiple internal electrode layers stacked in a height direction via dielectric layers, a top protective part made of a dielectric and positioned on a top side of a top internal electrode layer among the multiple internal electrode layers, and a bottom protective part made of a dielectric and positioned on a bottom side of a bottom internal electrode layer among the multiple internal electrode layers; and
a thickness of the bottom protective part is greater than a thickness of the top protective part so that the capacitive part is disproportionately positioned in an upper side of the capacitor body in the height direction.

2. A multilayer ceramic capacitor according to claim 1, wherein, when a height of the capacitor body is given by H, a thickness of the top protective part is given by Tb, and a thickness of the bottom protective part is given by Tc, then the height H and thickness Tb satisfy a condition of Tb/H≦0.06, while the height H and thickness Tc satisfy a condition of Tc/H≧0.20.

3. A multilayer ceramic capacitor according to claim 1, wherein, when the thickness of the top protective part is given by Tb and thickness of the bottom protective part is given by Tc, then the thickness Tb and thickness Tc satisfy a condition of Tc/Tb≧4.6.

4. A multilayer ceramic capacitor according to claim 2, wherein, when the thickness of the top protective part is given by Tb and thickness of the bottom protective part is given by Tc, then the thickness Tb and thickness Tc satisfy a condition of Tc/Tb≧4.6.

5. A multilayer ceramic capacitor according to claim 1, wherein, when the height of the capacitor body is given by H and its width is given by W, the height H and width W satisfy a condition of H>W.

6. A multilayer ceramic capacitor according to claim 2, wherein, when the height of the capacitor body is given by H and its width is given by W, the height H and width W satisfy a condition of H>W.

7. A multilayer ceramic capacitor according to claim 3, wherein, when the height of the capacitor body is given by H and its width is given by W, the height H and width W satisfy a condition of H>W.

8. A multilayer ceramic capacitor according to claim 4, wherein, when the height of the capacitor body is given by H and its width is given by W, the height H and width W satisfy a condition of H>W.

9. A multilayer ceramic capacitor according to claim 1, wherein a composition of the top protective part and that of the bottom protective part are the same as a composition of the dielectric layer.

10. A multilayer ceramic capacitor according to claim 1, wherein:
a composition of the top protective part and that of the top part of the bottom protective part are the same as a composition of the dielectric layer; and
a composition of the bottom part of the bottom protective part excluding its top part is different from a composition of the dielectric layer.

11. A multilayer ceramic capacitor according to claim 1, wherein:
a composition of the top protective part is the same as a composition of the bottom protective part; and
a composition of the top protective part and that of the bottom protective part are different from a composition of the dielectric layer.

12. A multilayer ceramic capacitor according to claim 1, wherein:
a composition of the top protective part is different from a composition of the bottom protective part; and
a composition of the top protective part and that of the bottom protective part are also different from the composition of the dielectric layer.

13. A multilayer ceramic capacitor according to claim 1, wherein:
a composition of the top protective part is the same as a composition of the top part of the bottom protective part;
a composition of the top protective part and that of the top part of the bottom protective part are different from a composition of the dielectric layer; and
a composition of the bottom part of the bottom protective part excluding its top part is also different from a composition of the top protective part and that of the top part of the bottom protective part and from a composition of the dielectric layer.
